(19) United States
(12) Patent Application Publication
(10) Pub. No.: US 2006/0040081 A1
(43) Pub. Date: Feb. 23, 2006

(54) Apparatus, system, and method for personalizing a portable electronic device

(76) Inventors: Jerry Grant Hodsdon, Forestdale, MA (US); Charles T. Wilson, Seal Beach, CA (US); James Frederick Citron, Los Angeles, CA (US); Keith Andrew Newburry, La Canada, CA (US)

Correspondence Address: RICHARD B. CATES, #B-697, 703 PIER AVENUE, HERMOSA BEACH, CA, 90254, US

(21) Appl. No.: 10/925,118

(22) Filed: Aug. 23, 2004

(51) Int. Cl. B32B 33/00

(52) U.S. Cl. 428/40.1; 428/42.3; 428/43

(57) ABSTRACT

An apparatus, system, and method for decorating a mobile telephone or other personal electronic device uses a decorative label placed within one or more transparent and removable cover portions of the personal electronic device. The invention uses a printable sheet having a backing layer, adhesive layer, and printable face layer. The adhesive is bonded to the backing layer with greater force than to the face layer. The printable face layer has one or more labels cut therein. A user can select a desired decorative and/or functional pattern and print that pattern on the printable face layer. The user can then peel the label or labels away from the printable sheet, with the adhesive remaining on the backing layer.

### FIELD OF THE INVENTION

The present invention relates to portable electronic devices and, more particularly, to an apparatus, system, and method for personalizing such devices in accordance with the desires of the user by way of a custom label sized to fit on or in an aperture of the housing of the device.

### BACKGROUND OF THE INVENTION

Portable electronic devices, such as mobile telephones, pagers, personal data assistants (pda's), and handheld video-game devices are in wide use. It is a desire among many users of such devices to add an element of personalization through some form of decorative modification, both as a means of identification, so as to make it separate and distinct from other mobile telephones and devices, and also as a form of self expression. One method for adding a decorative element to mobile telephones is through the replacement of a removable face plate with a pre-decorated face plate. Such pre-decorated face plates are available in many colors and designs, such as patterns representing leopard fur, etc. Such pre-decorated face plates are usually of a specific construction that is applicable to only a single model of phone. In order to provide many designs for different phones, the retailer must stock many packages, each containing one preprinted design for a particular mobile phone.

Another method for decorating personal electronic devices is by the application of a pre-printed self-adhesive label or face plate to the exterior of the device. Such labels can include various decorative patterns to personalize the device. Such labels can be sized to fit the particular device, and can be formed with various adhesives to secure the label to the device.

Another method for adding a decorative element to a device is to make the device to include a casing which has removable and transparent elements on the front and/or the back of the device. Once one or both of these elements are removed, the user can insert decorative labels that fit into the cavities in the device. The user then replaces the clear removable elements of the casing to capture and protect the decorative inserts. The user may choose to place such decorative inserts in the front and/or the back of the device. Manufacturers can thus make clear faceplates where they otherwise did not before since the insert can be used to customize the phone appearance. Some current models of mobile telephones incorporate this method of decoration, and the manufacturer may include several pre-designed, pre-cut inserts with the telephone when it is sold to the consumer. Such precut inserts typically have the holes for the buttons on the cellular telephone key pad precut and with the paper therein removed. In addition, several sheets of ink jet printable media may also be provided. These sheets can be semi-rigid paper material with die cuts that define both the outer perimeter of the front and rear labels, but which also define the numerous holes that are required for the device, such as holes necessary on a mobile telephone key pad and/or visual display panel. In order to keep the sheet integrated, each cut is interrupted at various locations by an uncut connecting segment, commonly referred to in the industry as a tie. The oval or circular cuts for the keypad buttons typically have at least two ties, and the perimeter cuts have numerous ties to connect the inserts to the carrier sheet. Once the user has printed text or graphics on the inserts utilizing an ink jet printer or by some other means, the user must then break each of those numerous ties individually in order to prepare the insert for placement into the mobile telephone cavities. This process is somewhat time consuming and requires a certain degree of manual dexterity to complete, and may result in rough edges on the insert.

Accordingly, there has been a need for an improved apparatus, system, and method whereby a user can easily and inexpensively prepare and install a decorative printable label for personal electronic devices that is easy to customize, prepare, and install. The present invention satisfies one or more of these needs.

### SUMMARY OF THE INVENTION

The present invention is directed to a system, apparatus, and method for creating a suitable decorative label which may be printed by a computer printer or some other means. In one embodiment, and by way of example only, the front and/or back labels are removed from a carrier, and the middle section of any holes within the label stay with the carrier. Therefore each decorative label can be easily and cleanly removed from the carrier, ready for insertion into the mobile telephone cavities with little effort.

One embodiment of the invention is a printable sheet, comprising a backing layer, face layer, and an intermediate material such as an adhesive layer. The face layer includes a selected perimeter and/or outlines of one or more labels precut therein, with the labels including holes corresponding to portions of the device. The labels (including the holes therein) are defined by weakened separation lines in the face layer, the weakened separation lines formed by cutting through or otherwise weakening desired portions of the face layer. An intermediate material lies between the backing layer and face layer. The intermediate material may include an adhesive layer that adheres to the backing layer with greater force than to the face layer. When a desired portion of the face layer (such as a precut label) is peeled away from the printable sheet, the adhesive layer stays behind on the backing layer, as do the other portions of the face layer (such as holes precut into the label itself). This assembly is the opposite of typical label material, where the adhesive is removed from the backing and stays on the removed label instead.

In a further embodiment of the invention the backing layer includes a primer applied to a side facing the adhesive, which increases the force with which the adhesive bonds to the backing layer. In another embodiment the face layer includes a release coating applied to a side facing the adhesive, which reduces the force with which the adhesive bonds to the face layer. A release film may be included to facilitate separation of the adhesive layer from the face layer. One embodiment of such a release film involves a multilayer laminate film having multiple film layers that can be separated with relative ease. An example of such a laminate includes a first film layer bonded and/or forming a face-layer-facing side of the adhesive layer, and a second film layer secured to and/or forming the adhesive-facing side of the face layer. When the face layer is peeled away from the liner, the film laminate splits, with the first film layer staying with the adhesive layer and the second film layer staying with the face layer. It is noted that although the different layers of the multilayer film laminate may be initially formed together, once the first side layer is adhered to the adhesive it can be viewed as being a part of the adhesive layer, and similarly the second side layer once secured to the face layer can be viewed as being a part of the face layer. Examples of such multilayer laminate films are disclosed in U.S. Pat. No. 4,837,088 which issued on Jun. 6, 1989 and is entitled “Coextruded Core Laminates,” the entire contents of which are incorporated herein by reference.

The labels preformed onto the face layer can be configured for various devices, including mobile telephones, pagers, personal data assistants, handheld video game devices, and different models thereof. A single printable sheet can have a face layer that incorporates labels for multiple devices and/or models and brands thereof. A package of such printable sheets can thus provide labels applicable to numerous models and/or brands of electronic devices. Such an embodiment would allow a retailer to substantially reduce the number of individual retail items (often referred to as SKU's) they would have to carry to provide inserts for customizable electronic devices. The retailer can order one or more packages of labels, with a package having a plurality of labels configured for application to one or more electronic devices. After receiving the packages, the retailer need only maintain a few, or even one, type of package for sale on the shelves of the retail store.

The user can purchase a printable sheet, select a desired pattern, print the desired pattern onto the face layer of the printable sheet, peel the label portion or portions from the printable sheet, remove the cover or covers from the desired device, place the labels between the cover and the device, and resecure the cover to the device. When the user decides to change the desired pattern, the user can print another desired pattern onto the face lay of a printable sheet and repeat the process. The user can print the desired pattern in various ways, including by hand, via a computer printer, etc. The printable sheet can also be preprinted with a pattern by the manufacturer. The invention may be used with various types of print media that may be used for the printable sheet. One type of print media may be a spot metallic print media that has a printable coating that becomes transparent when printed with inkjet inks.

The invention can be applied to creating labels for various items, including portable electronic devices such as mobile telephones, pagers, personal data assistants (pda's), handheld video-game devices, remote controls, personal audio, personal video, and laptop computers. Labels could also be created for mobile and/or desktop phones, door entry keypads, and other items requiring a label with cutouts. Such an embodiment could include a backing layer and a face layer in the form of or having a printable decorative label, with the label having one or more weakened internal opening outlines defining desired cutout portions. The weakened internal opening outlines can be shaped and positioned to correspond to various features of the item, such as operational keys of a device, visual components of a device such as a viewscreen or drawing, and/or audio components of a device such as a speaker or microphone.

Other features and advantages of the present invention will become apparent from the following detailed description, taken in conjunction with the accompanying drawings which illustrate, by way of example, the principles of the invention.

### BRIEF DESCRIPTION OF THE DRAWINGS

FIG. 1 is a front view of a printable sheet according to an embodiment of the invention;

FIGS. 2a-2c are side views of a printable sheet according to various embodiments of the invention;

FIG. 3 is a front view of the printable sheet of FIG. 1 with a design printed thereon according to an embodiment of the invention;

FIG. 4 is a front view of the printable sheet of FIG. 1 depicting a label being peeled away from the backing portion according to an embodiment of the invention;

FIG. 5 is a front view of the printable sheet of FIG. 1 after the label has been removed from the backing portion according to an embodiment of the invention;

FIG. 6 is a front view of the labels after being removed from the backing layer according to an embodiment of the invention;

FIG. 7 is a perspective view of a mobile telephone configured for use with decorative labels according to an embodiment of the invention;

FIG. 8 is a perspective view of the mobile telephone of FIG. 7 with a removable transparent front cover portion being removed according to an embodiment of the invention;

FIG. 9 is a perspective view of a decorative label installed inside a transparent front cover portion according to an embodiment of the invention;

FIG. 10 is a perspective view of a decorative label installed inside a transparent back cover portion according to an embodiment of the invention; and

FIG. 11 is a front view of a printable sheet having labels for multiple mobile telephone models according to an embodiment of the invention.

### DETAILED DESCRIPTION OF THE INVENTION

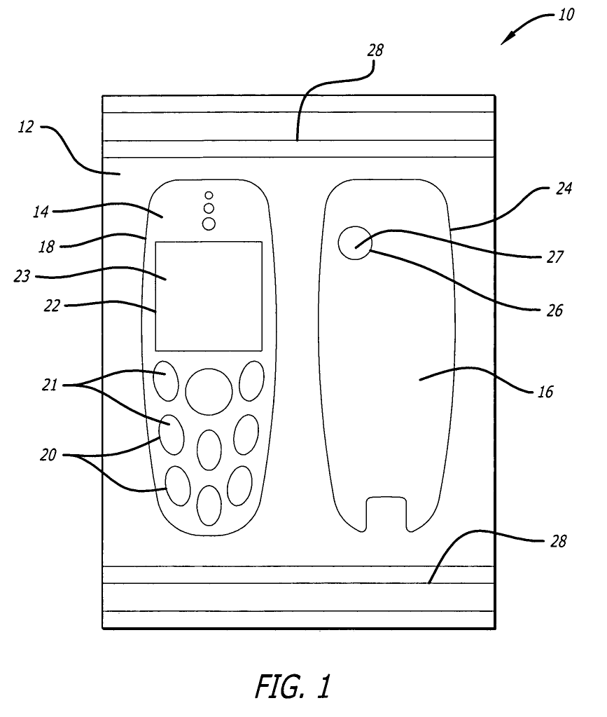

FIG. 1 depicts a front view of a printable sheet 10 according to an embodiment of the invention. The printable sheet 10 includes a face layer 12. The face layer 12 can be made from a variety of materials, including paper or card stock, or an opaque, translucent, or clear film face stock or laminates. The face layer 12 material may be printable in an ink jet, laser, and/or other type of printer. The face layer 12 may also be personalized by hand through painting, writing, or applying stickers. The printable sheet could be of various sizes, depending on the particular application. For example, a 4″ by 6″ printable sheet may be appropriate for some mobile telephone labels. The printable sheet may also be in roll form, depending on the particular application. The design of the sheet 10 could be adapted to provide labels for various electronic equipment, including mobile phones, cameras, PDAs, games, and the like.

The face layer 12 has a front label 14 and a rear label 16 defined by weakened separation perimeter lines die cut or otherwise created on the face layer 12, with the front label 14 and rear label 16 configured for installation in the front and rear portions, respectively, of a mobile telephone. The front label 14 is defined by a front label perimeter outline 18 and internal opening outlines 20, 22 which correspond to front portions of a mobile telephone. In the embodiment depicted in FIG. 1, internal opening outlines 20 define cutout portions 21 which correspond to keys on a mobile telephone, while internal opening outline 22 defines a cutout portion 23 which corresponds to a view screen on a mobile telephone. The rear label 16 is defined by a rear label perimeter 24 and an internal opening outline 26 corresponding to rear portions of a mobile telephone. The internal opening outline 26 defines a rear cutout portion 27. While a front and rear label are described above, the face layer 12 can include labels intended for any location on the electronic device and need not include both a front and rear label.

In the specific embodiment described above with respect to FIG. 1, the label perimeters 18, 24 and opening outlines 20, 22, 26 may be defined by a weakened separation line, such as a die cut partially or fully through the face layer material. The weakened separation line may be a continuous cut around the desired perimeter or cutout portion, or may be interrupted at various locations by an uncut connecting segment, commonly referred to in the industry as a tie. The weakened separation line may be physically formed using various techniques. A laser may be used to cut completely or partially through a desired layer, or the laser may be used to otherwise weaken (with or without cutting) all or a part of the desired perimeter or opening outline. Mechanical cutting devices may also be used, as well as chemicals, for cutting and/or weakening the desired perimeter or opening outline. Such processes are know in the art.

The printable sheet 10 may also include a leading-edge weakened separation line 28 parallel to either end, which can improve the ability of some printers to feed the printable sheet through the print feed mechanisms by increasing the flexibility of the leading edge. This leading-edge weakened separation line 28 may be particularly useful with heavier face layer materials which may be less flexible and more prone to jamming when fed into a printer feeder. In the embodiment of FIG. 1, the weakened separation lines 28 are on the face layer 12. Depending on the particular embodiment, the weakened separation line 28 may pass through the backing layer 32, adhesive layer 30, and/or face layer 12. Such leading-edge weakened separation lines are discussed in detail in U.S. Utility patent application Ser. No. 10/641,132, Publication No. 2004/0091659, filed Aug. 14, 2003 and entitled “Identification Badge Construction,” which is hereby incorporated by reference in its entirety.

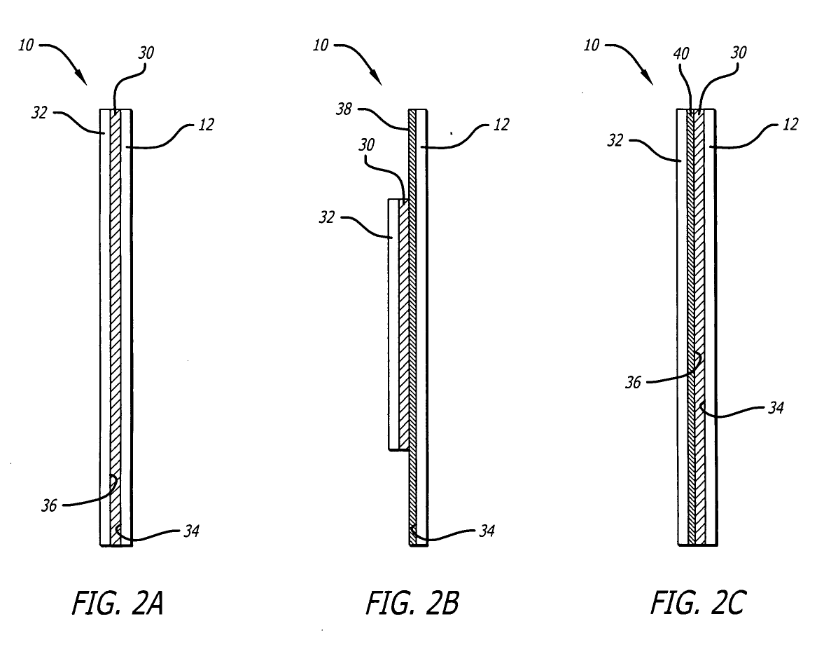

FIG. 2a depicts in side view the printable sheet 10 of FIG. 1. The printable sheet 10 includes the face layer 12, an adhesive layer 30, and a backing layer 32. The adhesive layer 30 lies between the face layer 12 and backing layer 32, and the printable sheet is configured so that that adhesive layer 30 adheres more strongly to the backing layer 32. Accordingly, when all or portions of the face layer 12, such as the labels 14, 16 of FIG. 1, are peeled away from the backing layer 32, the adhesive 30 will remain on the backing layer 32. It should be appreciated that the term “layer” as used in this specification and claims refers not only to materials having a substantially uniform composition, but also to dissimilar materials arranged together. For example, a “layer” may comprise multiple layers or sections of similar or dissimilar materials.

The face layer 12 may be formed from one or more types of materials, including various types of papers, photo papers (including photo glossy), films, synthetic papers, or cardstocks. The face layer may have one or more topcoatings applied that are designed to enhance print quality. For example, a topcoating may be included that enhances print quality with one or more specific printing technologies, such as inkjet printing. The face layer could also have one or more coatings applied to provide a specific appearance—such as glossy, matte, colors, textures, etc. The face layer 12 could include metallized films, paper/foil laminates (to provide a metallic surface appearance), holographic materials (paper or film), prismatic, and/or phosphorescent coatings (glow-in-the-dark).

The face layer 12 may be formed using a print media such as that disclosed in U.S. Utility patent application Ser. No. 09/872,353, Publication No. 2002/0047263, filed Jun. 1, 2001 and entitled “Business Card Sheet Construction and Methods of Making and Using Same,” the entirety of which is hereby incorporated by reference. Such print media may use a material which is a printable card stock that may be die-cut into desired shapes, but held together to an overall sheet assembly by a dry laminate or other non-pressure-sensitive adhesive to a backing layer. Alternatively, an ultraremovable adhesive to a carrier or a tape along the die-cuts may be used to maintain the shapes to the sheet assembly. The print media may be peeled away from the sheet assembly leaving clean edges and no adhesive or sticky residue on the print media.

The overall thickness, length, and width of the printable sheet 10 can vary, depending on the particular application, including the printer to be used (if any), the materials involved, etc. A general range for such thicknesses is 1.5-15 mils. The low end of this thickness range may involve film materials, such as a perforated polyester film. The high end of this thickness might involve paper, laminate, and/or cardstocks. For example, one type of clean edge material involves a thickness of approximately 14 mils. Thicknesses less than 1.5 mil and greater than 15 mils are also possible, although sheets having such thicknesses may have difficulty being fed through many computer printers.

Backing layer materials could include film liners (such as polyester or polyolefin), polycoated liners, and paper liners. The thickness of the backing layer 32 can also vary depending on the particular application, materials, etc. For example, a thickness of 1 mil may apply to a polyester backing layer, while a thickness of about 5 mil may be applicable to paper liners.

The adhesive layer 30 may comprise one or more types of adhesives, including ultra-removable adhesives, pressure-sensitive adhesives, permanent adhesives (possibly combined with appropriate release agents), dry tack adhesives, and/or other adhesives.

Bonding the adhesive layer 30 more strongly to the backing layer 32 can be accomplished in any of several ways. In one embodiment, the face layer 12 has an adhesive-facing side 34 which is relatively smooth compared to a more porous adhesive-facing side 36 of the backing layer. In another embodiment, depicted in FIG. 2b, the face layer 12 includes a release coating 38 on the adhesive-facing side 34. The release coating 38 decreases the force with which the adhesive layer 30 would otherwise adhere to the face layer 12. In a further embodiment, depicted in FIG. 2c, the backing layer 32 includes a primer layer 40 on the adhesive-facing side 36 which increases the adhesive force with which the adhesive layer 30 adheres to the backing layer 32.

The backing layer 32 and adhesive layer 30 may be the same length and width as the face layer, as depicted in FIG. 2a. Alternatively, the backing layer 32 and/or adhesive layer 30 may be sized differently from the face layer 12. For example, as depicted in the embodiment of FIG. 2b, a portion of the backing layer 32 and adhesive layer 30 may be removed at one or both ends of the printable sheet 10, which may improve the feeding of the printable sheet 10 through some types of printer feeding mechanisms.

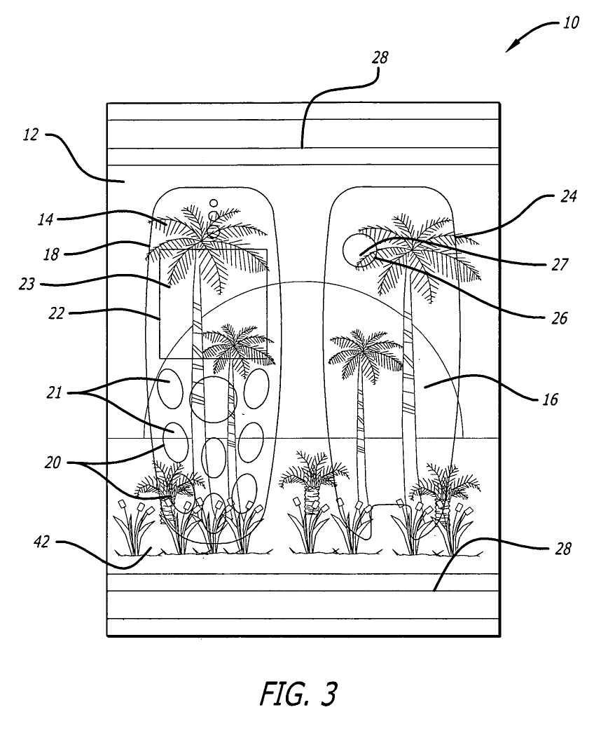

The printable sheet 10 can be decorated with a selected pattern, which may include pictures, designs, names, letters, numbers, symbols, colors, textures, combinations thereof, etc. FIG. 3 depicts the printable sheet 10 of FIG. 1 after a desired pattern 42 has been applied thereon. The desired pattern can be applied in various ways, such as by printing the desired pattern on the printable sheet 10 via an ink jet printer. As an example, a user could create a desired pattern using software, and/or could select and/or download a desired pattern from the internet, a digital camera, or other media. A web based system could be used to prepare the desired pattern. Examples of such systems are disclosed in U.S. application Ser. No. 09/684,055 filed Oct. 6, 2000 and entitled “System and Method for Generating Customized and/or Personalized Documents,” and in U.S. application Ser. No. 09/912,188 filed Jul. 24, 2001 and entitled “System and Method for Generating Customized and/or Personalized Documents,” the entire contents of both of which are incorporated herein by reference. Various types of software could be used in creating the desired pattern, including commercially-available software such as Adobe Photoshop and Microsoft Paint. Such software may be modified, and/or specific software could be developed on its own, to facilitate design and/or printing of a desired pattern onto the printable sheet of the invention. In addition, the features of DesignPro software sold by Avery Dennison Corporation, could also be used or modified for use. The desired pattern could also be customized by hand through painting, sketching, writing, application of stickers, and other arts and crafts techniques.

With the desired pattern selected, it may need to be sized appropriately to fit onto the label in a desired fashion. Such sizing may be automatically performed by the software, and/or manually selected and/or guided by the user. For example, the software may suggest a preferred size and give the user the opportunity to modify that size. The software may also provide the desired location on the printable sheet 10 on which to apply the image, and/or the user may modify the suggested location or select the location without suggestion from the software. For example, the user may position the desired pattern in such a way as to prevent particularly desirable features of the pattern from being printed on the cutout portions 21, 23, which will be left behind on the backing and thus not present or visible when the label is placed on or in the cell phone. The software may also have the ability to map the cutout portions 21, 23 and size and position the desired pattern so that only minimal features of the desired pattern are printed onto the cutout portions 21, 23.

Once the desired pattern has been selected, it can be applied to the printable sheet via the user's printer. The desired pattern could also (or alternatively) be printed or otherwise placed onto the printable sheet as a part of the manufacturing process (i.e., prior to the purchase of the sheet by the consumer). In addition to ink jet printing, the face layer 12 may also be compatible with other printing techniques, including color laser, monochrome laser, dye sublimation, thermal transfer, direct thermal, electrophotographic printing, and/or electrostatic printing. The desired pattern could even be applied to the face layer 12 by hand, such as by the use of colored pens or pencils, paint brushes, hand-applied stickers, etc. Additionally, the face layer 12 can be pre-printed (i.e., prior to sale to the end consumer) using standard printing technologies such as flexo, offset, and gravure.

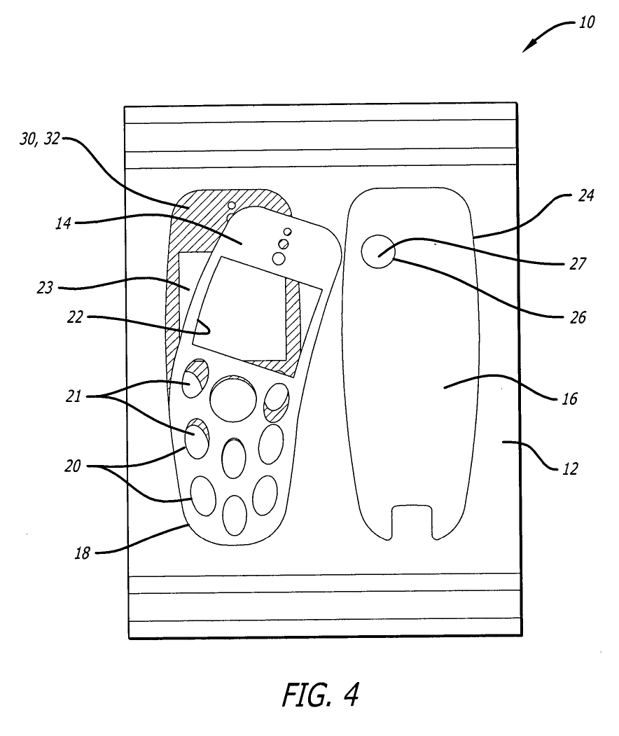

After the desired printing pattern has been applied to the printable sheet 10, the user can remove the labels. FIG. 4 depicts the front label 14 being peeled away from the backing layer 32. Note that desired pattern 42 would be present in the practice of the invention as the labels 14, 16 are peeled from the backing layer 32, but is not depicted in this and subsequent figures in order to more clearly show the perimeters, internal opening outlines, etc. Because the adhesive layer 30 is adhered more strongly to the backing layer 32 than to the face layer 12, the adhesive layer 30 remains secured to the backing layer 32 as the label 14 is peeled away. Also, the portions 21, 23, 27 of the face layer defined within the internal opening outlines 20, 22, 26 will separate from the face layer 12 at the outlines 20, 22, 26 and remain adhered to the adhesive layer 30 and backing layer 32. Thus, the labels can be easily removed from the backing layer 30 with their perimeters and necessary keyholes, etc. already formed. It may be advantageous to back cut the liner itself to encourage the cutouts to stay with the liner. In other words, a portion of the label perimeter outlines 18, 24 and/or internal opening outlines 20, 22, 26 may be cut all the way through the face stock and the liner to facilitate peeling. This could be the portion of all the weakened lines closest to the bottom of the sheet for example. If the user is instructed to peel the label from the bottom of the sheet upward, each internal area could be more likely to stay with the liner, depending on the configuration and materials used for a particular application of the label. Examples of such back cuts are disclosed in PCT Application No. PCT/US2003/01808, filed on Jan. 22, 2003 and entitled, “Adhesive Label Liner Sheet Modifications for Retaining Unneeded Label Sections on Liner,” the entire contents of which are incorporated herein by reference.

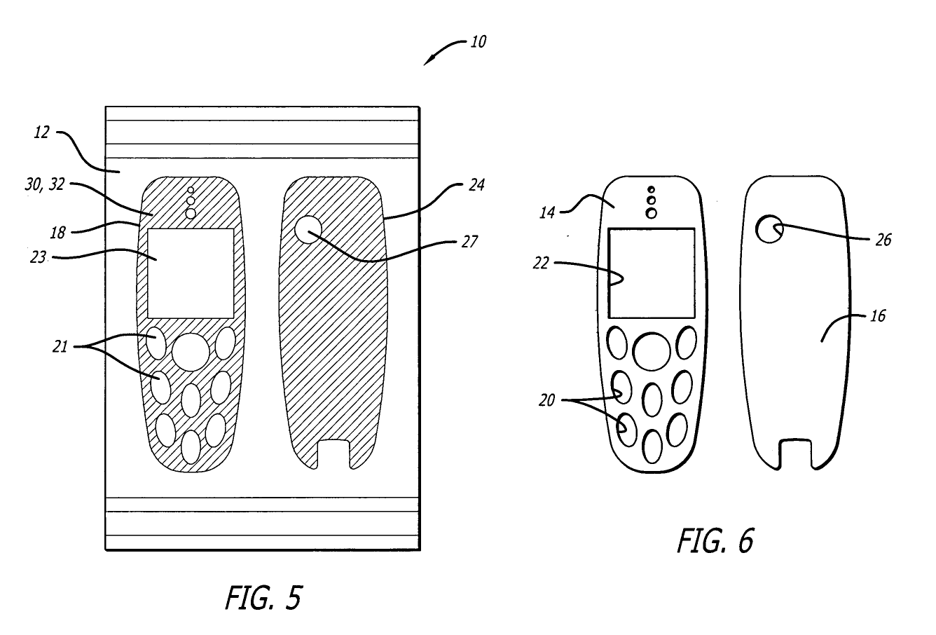

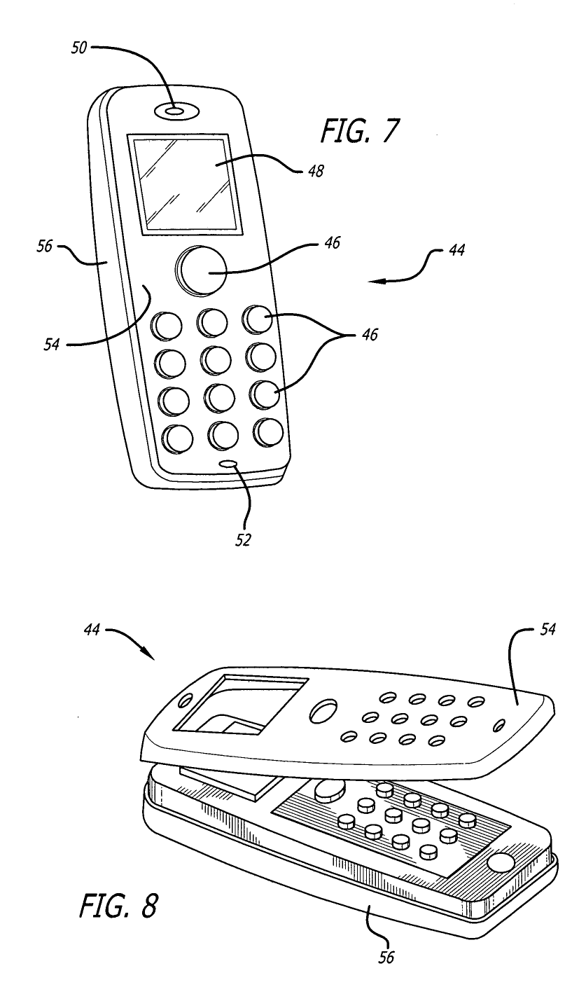

Once the labels 14 and 16 are removed from the backing layer 32, the remaining portion of the printable sheet 10 is as depicted in FIG. 5, with the backing layer 32, adhesive layer 30, and leftovers from the face layer 12 (e.g., portions 21, 23, 27 inside the internal opening outlines 20, 22, 26, respectively, and areas outside the label perimeters 18, 24) remaining. The labels 14, 16 are depicted in FIG. 6. Note that the portions 21, 23, 27 defined within the internal opening outlines 20, 22, 26 will have been removed from the labels as the labels were peeled from the backing layer, leaving holes in the label defined by the internal opening outlines 20, 22, 26. Also, no adhesive remains on the labels 14, 16. The labels 14, 16 are thus ready to be installed into the desired cavities in a mobile telephone, as depicted in FIGS. 7-10.

FIG. 7 depicts a mobile telephone 44 configured for use with the labels. The mobile telephone 44 depicted includes various keys 46, a view screen 48, a speaker 50, and a microphone 52. The mobile telephone 44 includes a front cover 54 and a back cover 56. The front cover 54 and/or the back cover 56 may be transparent in whole or in part in order to more effectively view decorative labels placed inside one or both covers.

FIG. 8 depicts the front cover 54 being removed from the mobile telephone 44. The back cover 56 may be removed in a similar fashion, depending on the particular mobile telephone model. The device may be configured to permit labels to be inserted without requiring removal of the transparent covers. For example, the device may be equipped with slots or other openings in the transparent covers through which labels may be inserted or withdrawn.

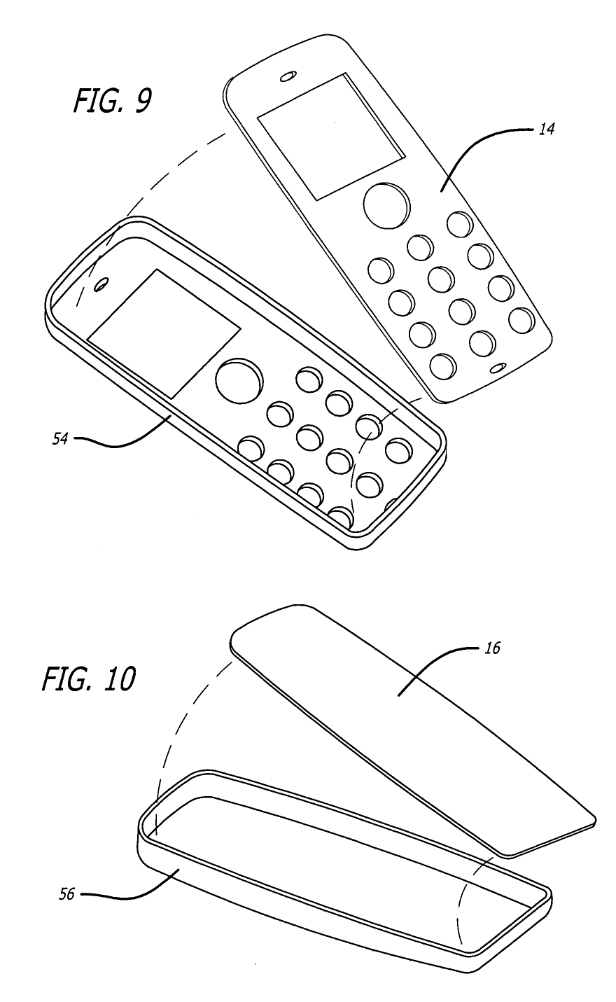

As shown in FIG. 9, the front label 14 is placed within the front cover 54, with the holes defined by the internal opening outlines 20, 22 corresponding to holes in the front cover that accommodate features such as keys, the view screen, the speaker, and/or the microphone of the mobile telephone. The front label 14 may be placed with the desired pattern facing outward, i.e., toward the front cover 54, so that the desired pattern can be viewed through the transparent front cover 54 when the front cover 54 is reinstalled on the mobile telephone 44. Alternatively, the front label may be placed with the desired pattern facing inwards, so that the desired pattern can only be seen by removing the front cover 54 from the telephone 44. Such a placement of the desired pattern could be used where the desired pattern comprises information such as access codes, etc., which the user may want to keep hidden from general view but still have accessible. Such placement of the desired pattern (with access codes) facing inward places the access codes in an accessible but hidden location where such codes can be retrieved by the user. Such hidden placement could also be achieved by using a front cover that is opaque in whole or in part, where the portion of the label bearing the access codes, etc., is hidden under the opaque portions of the front cover. With such an opaque cover, the label need not have the pattern facing inward.

FIG. 10 depicts the rear label 16 being placed within the back cover 56. The rear internal opening outline 26 or outlines define a hole or holes corresponding to features of the mobile telephone. The rear label may be placed with the pattern facing outward for viewing through a transparent portion of the back cover. The rear label may also be placed with the pattern facing inward, and/or be used with a back cover having opaque portions, as was the case with the front label 14 and front cover 54.

In the embodiment depicted in FIG. 9 the front label 14 is applied to a large area of the front of the cell phone 44, including the area around the buttons and the display. Similarly, the rear label 16 in FIG. 10 covers almost the entire back portion of the cell phone. However, depending on the particular application, including the make of cell phone and the desires of the user, a label according to the invention may be configured to be applied to only a portion of the cell phone area, such as only to the button area, or only to the display area. Such labels for reduced areas may be used with, for example, cell phones having removable covers that only cover the button area of the cell phone, or only cover the display area or the like.

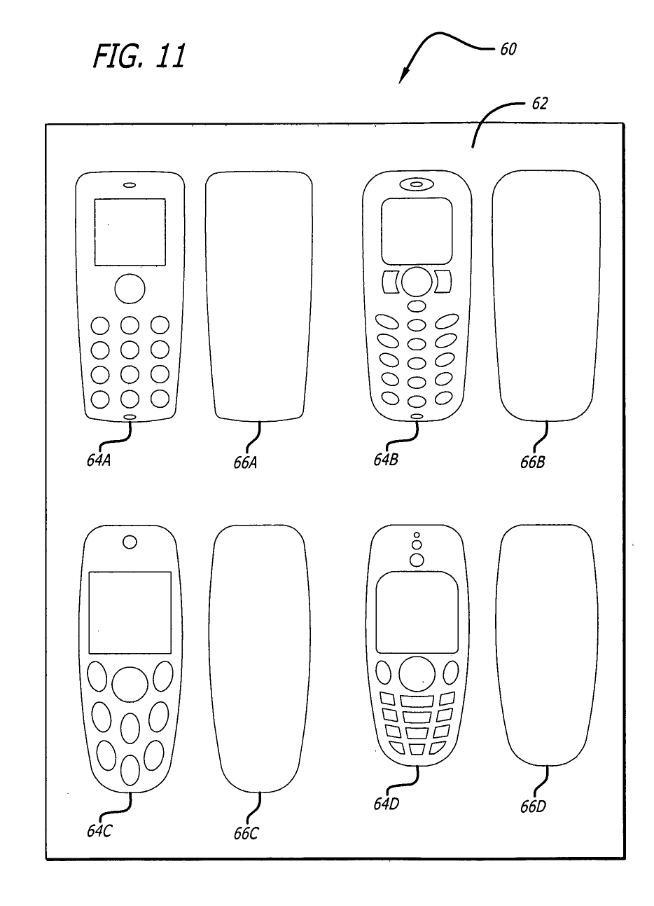

FIG. 11 depicts a further embodiment of the invention, where a single printable sheet 60 includes a face layer 62 having multiple front labels 64a-d and multiple rear labels 66a-d defined therein. The different labels can correspond to different models of electronic devices. For example, in the embodiment depicted in FIG. 11 the different labels correspond to different models of mobile telephones. With mobile telephones being made in increasingly small sizes, and with the corresponding labels able to be made in smaller sizes to match, a single 8½×11 sheet could potentially have labels cut thereon for four or more different models of mobile telephones. By including multiple labels for multiple models on a single sheet, and/or in a package of multiple sheets, a retailer could stock a single type or package of printable sheets to cover those multiple models. For example, a printable sheet and/or package of printable sheets could be prepared that included the most popular mobile telephone models from a particular mobile telephone manufacturer, so that a retailer would need to stock fewer, or perhaps even one, type or package of printable sheet for each brand of mobile telephone. In particular, one package could include sheets corresponding to all of the popular, current, or even discontinued phones of one or more manufacturers. Alternatively, a single printable sheet, and/or a package of multiple sheets, could include the most popular mobile telephone models regardless of manufacturer, so that a retailer could stock only one type or package of printable sheets and still meet the desires of many customers. Such an embodiment would allow a retailer to substantially reduce the number of individual retail items (often referred to as SKU's) they would have to carry to provide inserts for customizable electronic devices. This reduction in SKU's in turn, will provide multiple benefits to the retailer. It simplifies the retailer's supply chain, enabling the retailer to purchase, transport, store, stock and account for fewer items, and it will simplify replenishment by allowing the retailer to keep fewer products in stock to satisfy demand across all customizable devices. Additionally, fewer SKU's will take up less retail space, allowing the retailer to increase sales per square foot by allowing the retailer to address more devices with less space, and freeing up space for the sale of other accessories relating to the same handsets.

While the invention has been described with reference to particular embodiments, it will be understood that various changes and additional variations may be made and equivalents may be substituted for elements thereof without departing from the scope of the invention or the inventive concept thereof. For example, while the invention is specifically discussed in application with mobile telephones, it has applicability in other areas where it is desired to create labels. In addition, many modifications may be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A printable sheet, comprising:
a backing layer;
a face layer, the face layer comprising a printable surface with a first label outlined thereon, the label comprising an area defined by a weakened perimeter line on the face layer, the face layer further comprising one or more weakened internal opening outlines, at least one of the weakened internal opening outlines defining a desired cutout portion within the weakened perimeter line; and
at least one intermediate material, the intermediate material lying between and adhering to both the backing layer and the front layer, the intermediate material bonded to the backing layer with greater force than to the front layer.

2. The printable sheet of claim 1, wherein the weakened internal opening outlines are shaped and positioned to correspond to operational keys of a personal electronic device.

3. The printable sheet of claim 1, wherein at least one of the weakened internal opening outlines are cut entirely through the face layer.

4. The printable sheet of claim 1, wherein at least one of the weakened internal opening outlines are cut partially through the face layer.

5. The printable sheet of claim 1, wherein at least one of the weakened internal opening outlines comprises a cut at least partially through the face layer with the cut being interrupted by at least one tie.

6. The printable sheet of claim 1, wherein intermediate material comprises an adhesive layer.

7. The printable sheet of claim 6, wherein the backing layer further comprises:
a primer surface on an adhesive-facing side of the backing layer, the primer surface configured to increase the bonding force between the backing layer and the adhesive layer.

8. The printable sheet of claim 6, wherein the face layer further comprises:
a release surface on an adhesive-facing side of the face layer, the release surface configured to reduce the bonding force between the adhesive layer and the face layer.

9. The printable sheet of claim 8, where the release surface comprises a release coating.

10. A sheet, comprising:
a backing layer;
a face layer, the face layer comprising a printable surface with a first front label and a second front label outlined thereon, each of the front labels comprising an area defined by a weakened perimeter line on the face layer, the first front label comprising a first plurality of weakened lines defining a first plurality of outlines corresponding to operational keys of a first personal electronic device, and the second front label comprising a second plurality of weakened lines defining a second plurality of outlines corresponding to operational keys of a second personal electronic device; and
an adhesive layer, the adhesive layer lying between and adhering to both the backing layer and the front layer, the adhesive layer bonded to the backing layer with greater force than to the front layer.

11. The sheet of claim 10, wherein the first electronic device is a different model than the second electronic device model.

12. The sheet of claim 11, wherein the first electronic device and the second electronic device are of the same brand.

13. The sheet of claim 10, the face layer further comprising a first back label and a second back label outlined thereon, each of the back labels comprising an area defined by a weakened perimeter line on the face layer, the first back label having a shape corresponding to a back portion of the first electronic device, and the second back label having a shape corresponding to a back portion of the second electronic device.

14. The sheet of claim 10, wherein the first electronic device is a first mobile telephone and the second electronic device is a second mobile telephone.

15. A package comprising:
a plurality of sheets, each sheet having:
a backing layer,
a face layer, the face layer comprising a printable surface with a plurality of labels outlined thereon, each of said labels comprising an area defined by a weakened perimeter line on the face layer, and
an adhesive layer, the adhesive layer lying between and adhering to both the backing layer and the front layer, the adhesive layer bonded to the backing layer with greater force than to the front layer,
wherein each of the labels is configured to correspond to the shape of a desired portion of one or more electronic devices.

16. The package of claim 15, wherein most of the labels are configured to correspond to the shape of a single brand of electronic device.

17. A method for creating a label for a personal electronic device, the label contained in a printable sheet comprising: a backing layer; a face layer having a first removable label outlined therein, the first removable label comprising an area defined by a weakened perimeter line on the face layer, the perimeter line corresponding to a portion of the personal electronic device, the face layer further comprising a plurality of weakened internal outlines on the label, the weakened internal outlines defining cutout portions corresponding to keys of the personal electronic device; and an adhesive layer lying between and adhering to the backing layer and the face layer, wherein the adhesive layer is bonded to the backing layer with greater force than to the face layer; the method comprising the steps of:
selecting a desired printing pattern;
printing the desired printing pattern onto the face layer of the sheet; and
peeling the first removable label of the face layer away from the backing layer, wherein the adhesive and the cutout portions remain on the backing layer.

18. The method of claim 17, wherein selecting the desired printing pattern comprises designing the desired printing pattern.

19. The method of claim 17, wherein the printable sheet comprises a second removable label outlined therein, and the method comprises:
peeling the second removable label of the face layer away from the backing layer.

20. The method of claim 17, wherein printing the desired pattern comprises using a computer-driven printer to print the desired pattern on the face layer of the printable sheet.

21. The method of claim 17, further comprising:
selecting the area on the printable sheet on which to print the desired pattern.

22. A method for decorating a personal electronic device, comprising:
providing a personal electronic device having a removable external casing portion;
providing a printable sheet comprising:
a backing layer,
a face layer having a removable label outlined therein, the label comprising an area defined by a weakened perimeter line on the face layer, the perimeter line corresponding to a portion of the personal electronic device, the face layer further comprising a plurality of weakened outlines on the label, the outlines defining cutout portions corresponding to keys of the personal electronic device, and
an adhesive layer lying between and adhering to the backing layer and the face layer, wherein the adhesive layer is bonded to the backing layer with greater force than to the face layer;
selecting a desired printing pattern;
printing the desired printing pattern onto a front surface of the face layer of the sheet;
peeling the removable label of the face layer away from the backing layer, wherein the adhesive and the cutout portions remain on the backing layer; and
applying the removable label to the desired location on the personal electronic device.

23. The method of claim 22, wherein applying the removable label comprises:
removing the removable external casing portion from the personal electronic device; and
replacing the removable external casing portion onto the personal electronic device.

24. A method of reducing inventory of decorative face labels for mobile telephones at a retail store, comprising:
ordering at least one package of blank printable labels, the package having a plurality of blank printable labels configured for application to one or more mobile telephones;
receiving the package;
maintaining the package at a retail store location; and
selling the package.

25. The method of claim 24, wherein the plurality of blank printable labels are configured to fit upon different models of mobile telephones.

26. The method of claim 25, wherein the plurality of blank printable labels are configured to fit upon mobile telephones from a single manufacturer.

27. The method of claim 25, where the plurality of blank printable labels are configured to fit upon mobile telephones from a plurality of manufacturers.

28. A printable sheet, comprising:
a backing layer;
a printable decorative label, the printable decorative label comprising one or more weakened internal opening outlines defining one or more desired cutout portions on the printable decorative label; and
an adhesive layer, the adhesive layer lying between and adhering to both the backing layer and the printable decorative label, the adhesive layer bonded to the backing layer with greater force than to the printable decorative label.

29. The printable sheet of claim 28, wherein one or more of the weakened internal opening outlines are shaped and positioned to correspond to operational keys of a device.

30. The printable sheet of claim 28, wherein one or more of the weakened internal opening outlines are shaped and positioned to correspond to areas of a device not to be covered with the label.
